(19) United States
(12) Patent Application Publication
(10) Pub. No.: US 2013/0282171 A1
(43) Pub. Date: Oct. 24, 2013

(54) MEDICINE STORAGE APPARATUS

(71) Applicant: JVM CO., LTD., Daegu (KR)

(72) Inventor: Jun Ho KIM, Daegu (KR)

(73) Assignee: JVM CO., LTD., Daegu (KR)

(21) Appl. No.: 13/859,493

(22) Filed: Apr. 9, 2013

(30) Foreign Application Priority Data
Apr. 18, 2012 (KR) 10-2012-0040538
Apr. 18, 2012 (KR) 10-2012-0040542
Mar. 25, 2013 (KR) 10-2013-0031281

(51) Int. Cl. G06F 19/00

(52) U.S. Cl. CPC G06F 19/3456
USPC 700/236; 700/237; 700/231

(57) ABSTRACT

There is provided medicine storage apparatus. The apparatus may include a medicine storage case including a plurality of cells storing medicines therein, a door installed on a top surface of each of the cells and being opened and closed, a door opening/closing unit opening and closing the door, and a memory chip storing identification information for each of the cells while being initially manufactured and information of the medicines stored in each of the cells, and a medicine storage case mounting unit, on which the medicine storage case is mounted to be detachable, including a control unit controlling the door opening/closing unit to open the door provided in each of the cells.

### CROSS-REFERENCE TO RELATED PATENT APPLICATION

This application claims the benefit of Korean Patent Application Nos. 10-2012-0040538 filed on Apr. 18, 2012, 10-2012-0040542 filed on Apr. 18, 2012 and 10-2013-0031281 filed on Mar. 25, 2013, in the Korean Intellectual Property Office, the disclosure of which is incorporated herein in its entirety by reference.

### BACKGROUND OF THE INVENTION

1. Field of the Invention

The present invention relates to a medicine storage apparatus, and more particularly, to a medicine storage apparatus capable of not only storing various medicines but allowing only an administrator whose access right is authenticated to refill medicines or to provide medicines outwards.

2. Description of the Related Art

Generally, medical supplies are used to diagnose, treat, or prevent diseases of humans or animals, which include medicines and medical instruments.

In this case, medicines are manufactured to treat corresponding illnesses, have various kinds, and are produced in various forms such as tablets, powders, and parenteral injections.

As described above, to automatically keep various shapes and kinds of medicines and medical instruments, medicine storage apparatuses have been developed.

Medicine storage apparatuses are needed to discharge new medicines outwards or to refill new medicines if necessary. Typically, while refilling or discharging medicines, wrong medicines are refilled or discharged, thereby generating the misuse of the medicines.

Particularly, in the case of narcotics, opioids, psychotropic drugs, when being given to other patients who are not corresponding patients, patients taking the drugs may be greatly damaged. Accordingly, it is necessary to set permissions for how users access respective drugs to allow only an administrator having a justifiable right to refill or discharge corresponding drugs.

Accordingly, it is necessary to provide medicine storage apparatuses capable of complexly storing drugs having various sizes and shapes, supplying accurate medicines to patients, setting an access right of an administrator for each of individual medicines to check states of insertion, storage, and supplying in real time, and allowing only an administrator whose access right is authenticated to insert or refill drugs.

### SUMMARY OF THE INVENTION

An aspect of the present invention provides a medicine storage apparatus capable of storing medicines having various sizes and shapes, supplying corresponding stored medicines according to prescribing information of a prescription, or refilling medicines when corresponding medicines are exhausted.

An aspect of the present invention also provides a medicine storage apparatus individually opening and closing a door included in each of cells of a medicine storage case divided according to shapes and sizes of stored medicines.

An aspect of the present invention also provides a medicine storage apparatus capable of setting an access right for each of cells of a medicine storage case to allow only an administrator having a justifiable access right to refill or administrate medicines.

An aspect of the present invention also provides a medicine storage apparatus capable of improving efficiency in medicine stock management by checking stock information of medicines stored thereinside in real time.

The technical objects of the present invention are not limited to those described above, and it will be apparent to those of ordinary skill in the art from the following description that the present invention includes other technical objects not specifically mentioned herein.

According to an aspect of the present invention, there is provided a medicine storage apparatus comprising: a medicine storage case, which comprises a plurality of cells storing medicines therein, a door installed on a top surface of each of the cells and being opened and closed, a door opening/closing unit opening and closing the door, and a memory chip storing identification information for each of the cells while being initially manufactured and information of the medicines stored in each of the cells, and a medicine storage case mounting unit, on which the medicine storage case is mounted to be detachable, comprising a control unit controlling the door opening/closing unit to open the door provided in each of the cells.

The door may include a hooked element protruded from a bottom surface, and the door opening/closing may include a hooking element coupled with and released from the hooked element, a solenoid receiving power and allowing the hooking element to move in one direction, and a door detection element detecting whether the door is opened or not.

The medicine storage case mounting unit may include a drawer in which a space for storing the medicine storage case is provided therein, and a drawer mounting unit, on which the drawer is mounted to be arranged in a plurality thereof as at least one stage and to be slidable forward. The drawer may include a printed circuit board (PCB) electrically connected to the door detection element and the door opening/closing unit, and a case locking unit locking or unlocking the medicine storage case.

The control unit may include a withdrawal position detection unit detecting a withdrawal state of the drawer and a fixing unit fixing the drawer in a withdrawn state or unfixing the same and is provided in at least one of the drawer and the drawer mounting unit to control the door opening/closing unit and the fixing unit based on detection signals of the door detection element and the withdrawal position detection unit.

A front plate of the drawer may be installed to be hinge-coupled with bottoms of both sides of side plates to mount the medicine storage case therein or to detach the mounted medicine storage case and to be pivotable around the bottoms according to operation of a front opening/closing unit.

The front opening/closing unit may include brackets installed on both sides of a rear of the front plate and provided with an inclined slot hole, respectively, a first link element installed on outer surfaces of the side plates, provided with guiding protrusions, inserted into the slot holes of the brackets, installed on a fore-end thereof, and pivoting around a bottom, which is axis-coupled, a second link element whose fore-end is connected to the first link element and length is controlled by using a plurality of links, and a fastening module fastening and unfastening a fastening protrusion formed on a rear end of the second link element.

The fastening module may include a fastening element with a fastening groove, into which the fastening protrusion is inserted, and a lever element allowing the fastening element to pivot to fasten the fastening protrusion to be inserted into the fastening groove or to release the same.

The medicine storage case mounting unit may include a drawer in which a space for storing the medicine storage case is provided therein, and a drawer mounting unit, on which the drawer is mounted to be arranged in a plurality thereof as at least one stage and to be slidable forward. A front side of the medicine storage case may pivot upwards with the drawer as a reference and may be separated from the drawer.

When the front side pivots upwards, to allow the medicine storage case pivots around a rear side thereof, one of the rear side of the medicine storage case and the drawer corresponding to the rear side may include a pivoting guiding element formed to be depressed and another one thereof may include a pivoting guiding responding element formed to be protruded to correspond to the pivoting guiding element.

The drawer may include a pivoting blocking element protruded toward the front side of the medicine storage case. The medicine storage case may include a pivoting blocking responding element determining whether to pivot from the drawer by determining whether being hooked on the pivoting blocking element depending on whether a position is moved.

The drawer may include a pivoting force providing element providing a pivoting force to allow the front side of the medicine storage case to automatically pivot upwards when the pivoting blocking responding element is released from the pivoting blocking element.

The pivoting force providing element may maintain an elastically deformed state when the pivoting blocking responding element is hooked on the pivoting blocking element and may provide the pivoting force due to a restoring force for the elastic deformation when the pivoting blocking responding element is released from the pivoting blocking element.

A bottom end of the front side of the medicine storage case may include a pivoting force providing responding element containing the pivoting force providing element while the pivoting blocking responding element is hooked on the pivoting blocking element.

The medicine storage case mounting unit may include a memory recognition unit electrically connected to the memory chip and recognizing identification information and information of the medicines stored in the memory chip, and a communication module, to perform communication with a hospital server, transmitting the information recognized by the memory recognition unit to the hospital server and receiving refilling information of medicines necessary to be refilled from the hospital server.

The control unit may control the door opening/closing unit to open only the door of a corresponding one of the cells, to be refilled with medicines, according to the refilling information of medicines.

The medicine storage case mounting unit may include a display unit installed on a front thereof and displaying a menu screen for medicine-refilling operation and for authentication of an access right of an administrator, and an input unit for selecting one of menus displayed on the display unit and receiving a command to perform a desired operation.

The medicine storage case mounting unit may include a bottom guide element guiding bottoms of both sides of the medicine storage case while mounting the medicine storage case, and a top guide element fastening the both sides and a top surface of the medicine storage case.

The bottom guide element may include a pair of guide blocks installed to be extended long on both sides of the top surface of the medicine storage case. The pair of guide blocks may be installed to have an interval therebetween, corresponding to a width of the medicine storage case. Inclined surfaces may be formed on the pair of guide blocks to allow the interval of the pair of guide blocks to become wider than the width of the medicine storage case from an intermediate portion to a rear end.

Second terminals may be provided on a rear surface of the medicine storage case mounting unit to be coupled with a terminal connected to the memory chip of the medicine storage case. The memory recognition unit may recognize information stored in the memory chip via the first terminal and the second terminals. The control unit may allow the hospital server to certify authenticity of the medicine storage case by using the information recognized by the memory recognition unit.

The apparatus may further include a vacuum unit discharging the air contained each of the cells of the medicine storage case by forming a vacuum to remove dust and foreign substances. The control unit may control the vacuum unit to operate in a state in which all the doors installed in the respective cells of the medicine storage case are closed.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic perspective view illustrating medicine storage facilities including a medicine storage apparatus according to an embodiment of the present invention;

FIG. 2 is a schematic perspective view illustrating the medicine storage apparatus include in the medicine storage facilities of FIG. 1;

FIG. 3 is a schematic exploded perspective view illustrating a drawer and a medicine storage case included in the medicine storage apparatus of FIG. 2;

FIG. 4 is a block configuration view illustrating the medicine storage apparatus of FIG. 2;

FIG. 5 is a partial perspective view illustrating a configuration of a withdrawal position detection unit shown in FIG. 4;

FIGS. 6 and 7 are side views illustrating a configuration and operation states of a front opening/closing unit shown in FIG. 3;

FIGS. 8 and 9 are operation state views illustrating an inner configuration and discharging operations of cells shown in FIG. 3;

FIG. 10 is a schematic perspective view illustrating a door opening/closing unit shown in FIG. 4;

FIG. 11 is a schematic perspective view illustrating a medicine storage apparatus according to another embodiment of the present invention;

FIG. 12 is a schematic perspective view illustrating a drawer of the medicine storage apparatus of FIG. 11, which slides forward;

FIG. 13 is a schematic perspective view illustrating a medicine storage case included in the medicine storage apparatus of FIG. 11, which pivots upwardly from the drawer;

FIG. 14 is a schematic exploded perspective view illustrating the medicine storage apparatus of FIG. 11;

FIGS. 15 to 19 are schematic perspective views illustrating a process of mounting the medicine storage case included in the medicine storage apparatus of FIG. 11 on the drawer;

FIGS. 20 to 22 are schematic perspective views illustrating a process of separating the medicine storage case included in the medicine storage apparatus of FIG. 11 from the drawer;

FIG. 23 is a schematic exploded perspective view illustrating a medicine storage apparatus according to still another embodiment of the present invention;

FIG. 24 is a schematic perspective view illustrating the medicine storage apparatus of FIG. 23, viewed from another angle;

FIG. 25 is a block configuration view illustrating the medicine storage apparatus of FIG. 23;

FIG. 26 is a flowchart illustrating a method of controlling the medicine storage apparatus of FIG. 23; and

FIG. 27 is a configuration view illustrating another example of the medicine storage apparatus of FIG. 23.

### DETAILED DESCRIPTION OF THE INVENTION

Hereinafter, exemplary embodiments of the present invention will be described in detail with reference to the drawings. However, the present invention is not limited to the embodiments and a person skilled in the art understanding the spirit of the present invention may easily invent other examples included within the technical scope of the present invention through adding other elements or changing and deleting elements within the same technical scope, which may be considered as being included in the technical scope of the present invention. Also, the same reference numerals designate the same elements throughout.

Also, the same reference numerals designate the same elements throughout.

Also, in the present embodiment, medical supplies include medicines having various sizes and shapes, such as tablets, powders, and pouched drugs, and medical instruments such as syringes. However, for convenience of description, it has been described while commonly calling them medicines.

### Embodiment 1

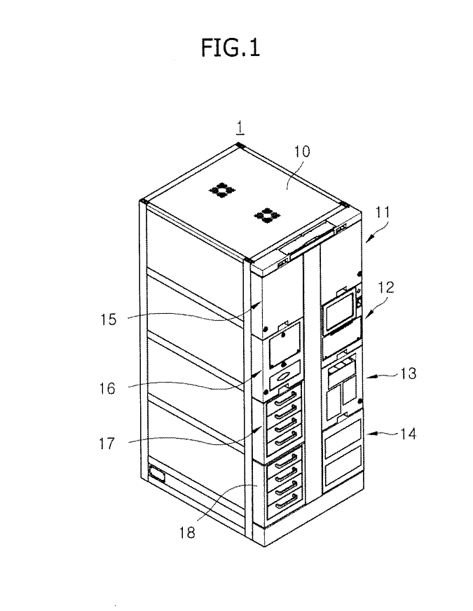

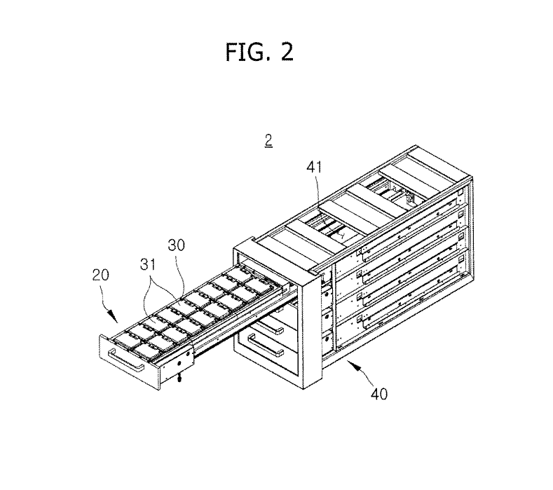

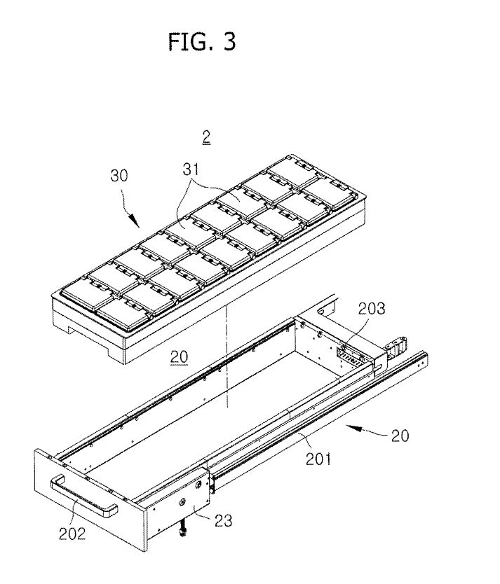

FIG. 1 is a schematic perspective view illustrating medicine storage facilities 1 including a medicine storage apparatus 2 according to an embodiment of the present invention, FIG. 2 is a schematic perspective view illustrating the medicine storage apparatus 2 included in the medicine storage facilities 1, and FIG. 3 is a schematic exploded perspective view illustrating a drawer 20 and a medicine storage case 30 included in the medicine storage apparatus 2.

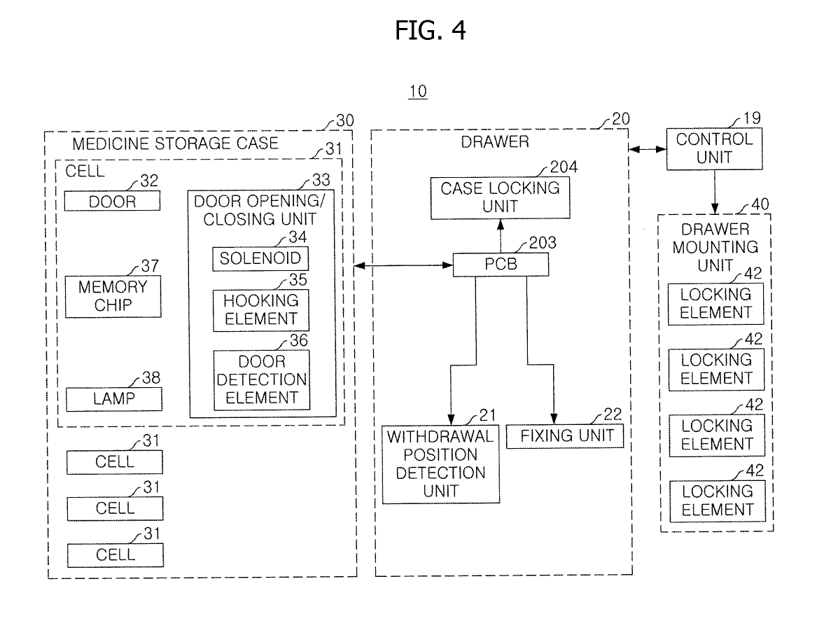

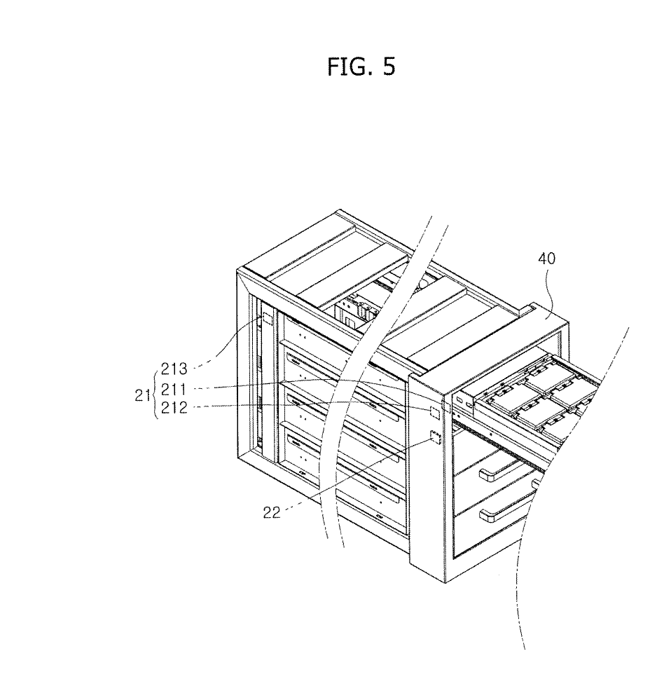

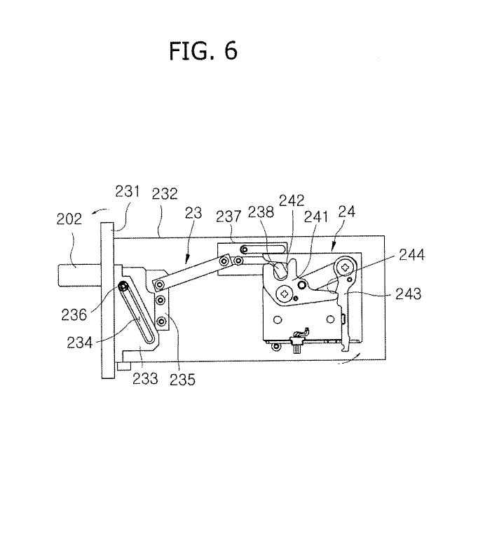

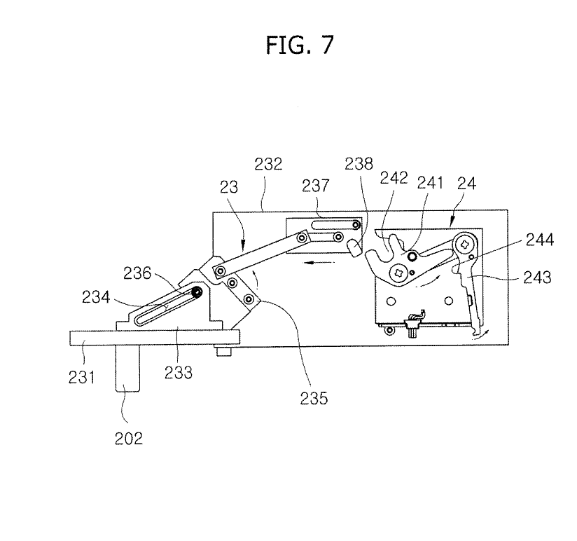

Also, FIG. 4 is a block configuration view illustrating the medicine storage apparatus 2, FIG. 5 is a partial perspective view illustrating a configuration of a withdrawal position detection unit 21 shown in FIG. 4, and FIGS. 6 and 7 are side views illustrating a configuration and operation states of a front opening/closing unit 23 shown in FIG. 3.

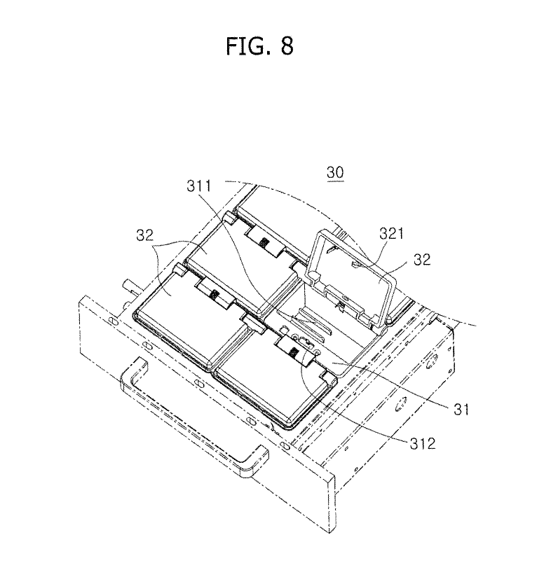

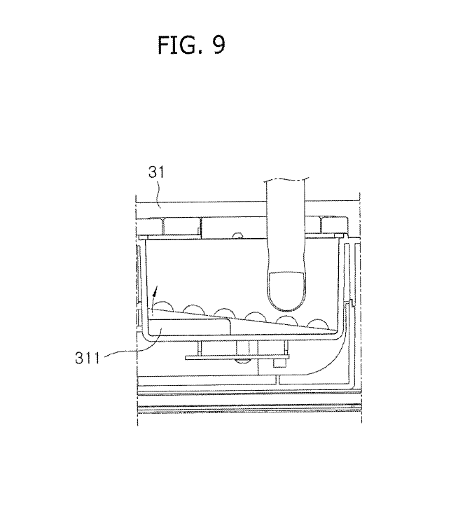

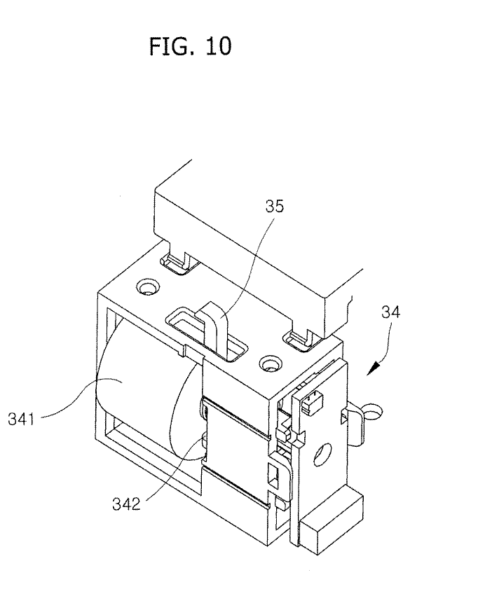

Also, FIGS. 8 and 9 are operation state views illustrating an inner configuration of cells 31 shown in FIG. 3 and an operation of discharging medicines, and FIG. 10 is a schematic perspective view illustrating a door opening/closing unit 33 shown in FIG. 4.

The medicine storage facilities 1 including the medicine storage apparatus 2, as shown in FIGS. 1 and 2, includes a main body 10, the drawer 20 installed in the main body 10 in a plurality thereof and containing the medicine storage case 30 storing medical supplies such as medicines and medical instruments (hereinafter, referred to as medicines) therein, and a drawer mounting unit 40, on which the drawers 20 arranged in a plurality of steps are mounted.

The main body 10 includes eight storage boxes 11 to 18 mounted as four stages on both right and left sides thereinside.

The respective storage boxes 11 to 18 are provided as installation spaces for installing the drawers 20, the drawer mounting unit 40, and units to store and discharge medicines, such as a display unit, an input unit, an authentication element, a control unit, and a communication module, which are coupled to be slidably movable toward a front of the main body 10.

Particularly, the respective storage boxes 11 to 18 are coupled with the main body 10 to be detachable to be exchangeable if necessary.

Accordingly, in the present embodiment, when the storage boxes 11 to 18, the drawers 20, or the drawer mounting unit 40 are damaged or disordered, a corresponding storage box may slide forward to be detached from the main body 10 in order to be replaced or repaired, thereby removing a limitation in a working space and improving workability while being maintained and repaired.

Fastening elements (not shown) may be installed in the respective storage boxes 11 to 18 in such a way that only an administrator having an access right may open the storage boxes 11 to 18 by sliding the same.

In the present embodiment, the drawer mounting units 40 are provided on a fourth storage box 14, from a right top of the main body 10 to below and third and fourth boxes 17 and 18 from a left top to below, respectively, mounting spaces 41 are formed with four stages in the respective drawer mounting unit 40, and the drawers 20 are mounted on the respective mounting spaces 41 of the drawer mounting unit 40.

That is, in the present embodiment, the storage boxes 11 to 18 are formed as a structure with multiple stages and are deposited in the mounting spaces of the drawer mounting unit 40 in such a way that the drawers 20 are mounted to be detachable, thereby effectively storing a plurality of medicines and easily separating the storage boxes 11 to 18 from the main body 10 and refilling the same when the drawer mounting units 40 or the drawers 20 have problems.

The drawer 20, as shown in FIGS. 2 and 3, is formed in the shape of a drawer provided with a storage space for storing the medicine storage case 30 therein, and sliding elements 201 are installed on both sides of the drawer 20 to allow an administrator to withdraw the drawer 20 by pulling the drawer 20 to slide forward from the inside of the drawer mounting unit 40.

In this case, the drawer 20 and the drawer mounting unit 40 may form a medicine storage case mounting unit, on which the medicine storage case 30 is mounted to be detachable.

That is, the drawer 20 slides forward without an additional driving device when the access right of the administrator is authenticated via the authentication element and then the administrator holds and pulls a handle 202 installed on a front surface of the drawer 20.

Also, a printed circuit board (PCB) 203 may be installed on a rear surface of the drawer 20, and the drawer 20 may include a case locking unit 204 locking and unlocking the medicine storage case 30 contained therein.

The PCB 203 is electrically connected to the respective cells 31 of the medicine storage case 30 and a control unit 19, which will be described below, transfers a control signal of the control unit 19 and power to the respective cells 31, and transfers information stored in a memory chip 37 in each of the cells 31 to the control unit 19.

Also, on a rear end of the drawer 20 and the inside of the drawer mounting unit 40, the withdrawal position detection unit 21 detecting a state of withdrawing the drawer 20 and a fixing unit 22 fixing the drawer 20 to be in a state of being perfectly withdrawn may be installed.

For example, the withdrawal position detection unit 21 includes a detection sensor such as a photo coupler.

That is, the withdrawal position detection unit 21, as shown in FIG. 5, includes a light emitting element 211 installed on a rear end of one side of the drawer 20 and emitting light, a first light-receiving element 212 installed on a position, where the drawer 20 inside the drawer mounting unit 40 is withdrawn to the full (hereinafter, referred to as a maximum withdrawal position), and detecting the light emitted from the light emitting element 211, and a second light receiving element 213 installed on a position, where the drawer 20 inside the drawer mounting unit 40 is inserted to the full, (hereinafter, referred to as a maximum insertion position), and detecting the light emitted from the light emitting element 211.

The withdrawal position detection unit 21 may be replaced by one light receiving element installed on the drawer 20 and two light emitting elements installed on the drawer mounting unit 40.

As described above, the withdrawal position detection unit 21 may detect a withdrawal position of the drawer 20 and transmits a detection signal according to the detected position to the control unit 19.

Accordingly, the control unit 19 controls the fixing unit 22 to fix the drawer 20, when the drawer 20 is withdrawn to the maximum withdrawal position, and controls to unfix the drawer 20, when a detection signal of detecting a closed state of a door 32 from an entire door detection element 36 of the medicine storage case 30, which will be described below.

Together with this, in the case of the drawer 20, as shown in FIGS. 6 and 7, to mount the medicine storage case 30 therein or detach the medicine storage case 30 mounted therein, a bottom end of a front plate 231 is hinge-coupled with both sides of a side plate 232 to be pivotable and the front plate 231 is fastened and unfastened to and from the side plate 232 by using the front opening/closing unit 23.

For this, on both sides of a rear surface of the front plate 231, brackets 233 with a slot hole 234 formed to be inclined are formed.

Also, on an outer surface of the side plate 232, there are installed a first link element 235 with a guiding protrusion 236 inserted into the slot hole 234 of the bracket 233, provided on a fore-end thereof, in which a bottom end of the first link element 235 is axis-coupled to allow the first link element 235 to pivot around the bottom end, a second link element 237 having a fore-end connected to the first link element 235 and a length controlled by using a plurality of links, and a fastening module 24 fastening and unfastening a fastening protrusion 238 formed on a rear end of the second link element 237.

The fastening module 24 includes a fastening element 241 with a fastening groove 242 into which the fastening protrusion 238 is inserted and a lever element 243 driving the fastening element 241 to pivot to fasten or unfasten the fastening protrusion 238 inserted into the fastening groove 242.

That is, in the present embodiment, to mount the medicine storage case 30 inside the drawer 20, as shown in FIG. 6, when the front plate 231 is vertically installed and then the lever element 243 included in the fastening module 24 is operated in one direction, a fore-end of the fastening element 241 engaged with a step 244 formed on one side of the lever element 243 is unfastened.

According thereto, the fastening element 241 pivots and unfastens a fastened state of the fastening protrusion 238 inserted into the fastening groove 242.

Then, the second link element 237, as shown in FIG. 7, moves leftwards and extends in length in such a way that the first link element 235 becomes pivotable around the bottom end.

Accordingly, in the present embodiment, when the front plate 231 is operated to pivot around a hinge axis, the guiding protrusion 236 of the first link element 235 is inserted into the slot hole 234 of the bracket 233 and a length of the second link element 237 extends, thereby opening the front of the drawer 20.

On the contrary, in the present embodiment, when the medicine storage case 30 is mounted inside the drawer 20 and then the front plate 231 is operated to vertically pivot, the lengths of the first link element 235 and the second link element 237 are reduced and move rightwards from a view in FIG. 7.

In this case, the fastening protrusion 238 of the second link element 237 is inserted into the fastening groove 242 of the fastening element 241 and operates the fastening element 241 to pivot clockwise, and the fore-end of the fastening element 241 is engaged with the step 244 formed on the one side of the lever element 243.

According thereto, in the present embodiment, it is possible to fasten a front plate to be vertical and to maintain a closed state.

In the medicine storage case 30, as shown in FIGS. 3 and 8, there is provided a plurality of the cells 31 to store medicines having various kinds, shapes, and sizes.

Each of the cells 31, as shown in FIG. 8, is formed of a box with an open top, in which a space for storing medicines is formed.

Also, each of the cells 31 includes the door 32 installed on the open top and being opened and closed, the door opening/closing unit 33 fastening and unfastening the door 32, and the memory chip 37 (refer to FIG. 4) storing information of medicines stored inside each of the cells 31.

On a part of a bottom surface of each of the cells 31, a plurality of guide ribs 311 to easily discharge medicines stored inside the cells 31 may be formed.

According thereto, an administrator, as shown in FIG. 9, may push one side of a medicine to lift up another side thereof mounted on a part where the guide rib 311 is formed and may easily discharge the medicine outwards by holding a lifted portion.

On the other hand, a size and a shape of each of the cells 31 may vary with a kind, a size, and a shape of a contained medicine or a shape and a size of a contained medical instrument.

That is, in the case of the medicine storage case 30, the cells 31 are formed in various sizes and shapes according to contained medicines and are stored inside a storage space of the drawer 20 to be slidable and detachable.

According thereto, in the present embodiment, one or more of a plurality of medicine storage cases including cells having various shapes and sizes according to medicines to be contained therein are selected and contained in a drawer. Accordingly, when the size or the shape of the medicines to be contained is changed, it is possible to exchange only a medicine storage case having a cell whose size or shape is changed and reuse the same, instead of exchanging the drawer or the entire drawer mounting unit.

Also, on a front top surface of each of the cells 31, as shown in FIG. 8, a penetration hole 312 is formed to allow a hooked element 321 of the door 32 and a hooking element 35 of the door opening/closing unit 33, which will be described below, to be coupled thereto.

The door 32 is hinge-coupled with a rear top end of each of the cells 31 and pivots around a hinge axis by a spring installed on the hinge axis.

On a front bottom surface of the door 32, the hooked element 321 engaged with the hooking element 35 of the door opening/closing unit 33 is formed to be protruded.

The door opening/closing unit 33, as shown in FIGS. 4 and 10, includes a solenoid 34 operating according to a control signal of the control unit 19, the hooking element 35 connected to a top end of the solenoid 34 and reciprocating to be coupled with and released from the hooked element 321 of the door 32, and the door detection element 36 detecting whether the door 32 is opened or closed.

The solenoid 34, as shown in FIG. 10, includes a coil 341 receiving power and generating a magnetic force, a moving element 342 horizontally moving due to the magnetic force generated by the coil 341, and a spring (not shown) installed on one side of the moving element 342 and providing a restoring force to the moving element 342.

The hooking element 35 is connected to a top of the moving element 342 and engaged with the hooked element 321. When the solenoid 34 receives power and the magnetic force is generated by the coil 341, the moving element 342 moves rightwards from a view in FIG. 5 in such a way that the hooking element 35 moves together with the moving element 342 and released from the hooked element 321.

On the contrary, when the power supplied to the solenoid 34 is cut off and the magnetic force is removed, the moving element 342 moves leftwards toward the coil 341 in such a way that the hooking element 35 horizontally moves together with the moving element 342 and then is coupled with the hooked element 321 when the door 32 is closed.

The door opening/closing unit 33 is connected to the PCB 203 included in the drawer mounting unit 40 by using a wire and receives the control signal of the control unit 19.

The memory chip 37 may include a read-only memory to prevent deleting and amending originally stored information.

On the other hand, in the present embodiment, the door 32 of each of the cells 31 is opened only when the entire cells 31 of the medicine storage case 30 are withdrawn outside the drawer mounting unit 40.

For this, each of the cells 31 of the medicine storage case 30 includes the door detection element 36 detecting whether the door 32 is opened or not and the control unit 19 controls the fixing unit 22 to unfix and to insert the drawer 20 into a mounting space 41 when the doors 32 of the entire cells 31 are closed and a detection signal detecting the closed state of the doors 32 is transferred from the respective door detecting units 36.

Also, a lamp 38 may be installed in each of the cells 31 of the medicine storage case 30.

The lamp 38 is turned on whether the door 32 is open or not in such a way that the administrator may easily check an open/closed state of the door 32.

The drawer mounting unit 40, as shown in FIG. 2, is formed in the shape of a rack provided with the mounting space 41 having multiple stages to mount a plurality of the drawers 20 deposited.

In the present embodiment, for example, the mounting space 41 is formed inside the drawer mounting unit 40 to load the four drawers 20 therein and an opening is formed on the front of the drawer mounting unit 40 to allow the respective drawers 20 to slide forward.

The drawer mounting unit 40 is provided as the storage box 17 and may be detached by sliding forward from the inside of the main body 10.

The drawer mounting unit 40 may further include a locking element 42 selectively locking and unlocking, provided for each of the drawers 20 mounted in the mounting space 41.

According thereto, in the present embodiment, an administrator takes a corresponding medicine included in prescribing information of a prescription and it is prevented that an administrator having no justifiable access right arbitrarily detach a drawer or mount another drawer containing a different medicine storage case, thereby accurately managing the stock of medicines and preventing accidents occurring due to administrating wrong medicines to patients.

On the other hand, in the present embodiment, the locking element 42 locking and unlocking the drawer 20 mounted in the drawer mounting unit 40 is distinguished from the fixing unit 22 fixing and unfixing the drawer 20 to control sliding thereof but is not limited thereto.

That is, the fixing unit 22 installed on the rear end of the drawer 20 may be used for performing the function of the locking element 42.

A method of operating the medicine storage apparatus according to an exemplary embodiment will be described in detail.

The medicine storage case 30 is mounted in a medicine refilling apparatus (not shown) separately manufactured, an access right of an administrator is authenticated, the door 32 provided on the top of each of the cells 31 of the medicine storage case 30 is opened, and medicines are put into each of the cells 31 and stored therein.

In this case, the medicine refilling apparatus may be controlled to open the whole doors 32 provided on the entire cells 31 of the medicine storage case 30 at the same time but may be controlled to set an access right of an administrator for each medicine and to open only the door 32 of a corresponding one of the cells 31, whose access right of an administrator is authenticated.

Then, the administrator inserts medicines into the cell 31, whose door 32 is opened, to refill the same.

On the other hand, the guide ribs 311 are formed on a part of the bottom surface of each of the cells 31 in such a way that the administrator inserts the medicines to be seated on the guide ribs 311.

When refilling medicines is finished and the administrator closes the door 32, the door detection element 36 transmits a detection signal of detecting a closed state of the door 32 to the medicine refilling apparatus and the medicine refilling apparatus controls the case locking unit 204 to unlock the medicine storage case 30 to be separated therefrom.

Via a procedure as described above, the medicine storage case 30 storing medicines is stored in the storage space of the drawer 20 mounted on the drawer mounting unit 40 and the drawer 20 finishing the storing of the medicine storage case 30 slides into the mounting space 41 of the drawer mounting unit 40.

In this case, a terminal connected to the PCB 203 of the drawer 20 is coupled with a terminal formed on the rear surface of the medicine storage case 30.

Together with this, the PCB 203 is connected to the control unit 19 by using a wire and receives a control signal therefrom.

Then, the PCB 203 transmits identification information and medicine information stored in the memory chip 37 provided for each of the cells 31 of the medicine storage case 30 stored in the drawer 20 to the control unit 19, receives a control signal of controlling opening and closing of the door 32 provided for each of the cells 31 from the control unit 19, and transmits the control signal to the door opening/closing unit 33 of each of the cells 31.

Also, the control unit 19 manages the stock of the medicines for each of the cells 31 by using the identification information and the medicine information transmitted from the memory chip 37, authenticates an access right of an administrator, and then controls operations of the medicine storage case 30, the drawer 20, and the drawer mounting unit 40 to discharge medicines according to prescribing information of a prescription administrated by the administrator.

A process of discharging medicines will be described in detail.

The locking element 42 included in the drawer mounting unit 40 is locking the drawer 20 to maintain a state of being mounted in the mounting space 41.

When the control unit 19 generates a control signal to open the drawer 20, the locking element 42 unlocks by operating the solenoid 34.

In this case, the withdrawal position detection unit 21 checks whether the drawer 20 slides forward and withdrawn.

That is, the light emitting element 211 installed on the rear end of the drawer 20 is driven by control of the control unit 19 to emit light in one direction, and the first and second light receiving elements 212 and 213 installed in the maximum withdrawal position and the maximum insertion position of the drawer 20 inside the drawer mounting unit 40 detect the light emitted from the light emitting element 211 and transmit detection signals to the control unit 19.

Then, the control unit 19 determines a withdrawal position of the drawer 20 according to the detection signals of the first and second light receiving elements 212 and 213.

When the drawer 20 is withdrawn to the maximum withdrawal position, the withdrawal position detection unit 21 transmits a detection signal of detecting the withdrawn drawer 20 to the control unit 19.

Then, the control unit 19 generates a control signal to open the door 32 of a corresponding one of the entire cells 31 of the medicine storage case 30 to discharge medicines according to the prescribing information of the prescription.

According thereto, the door opening/closing unit 33 of the entire or a part of the cells 31 of the medicine storage case 30 receiving the control signal from the control unit 19 generates a magnetic force and transfers the moving element 342 and the hooking element 35 to one side as power is supplied to the coil 341 of the solenoid 34.

In this case, when the power supplied to the solenoid 34 is cut off, the magnetic force is removed in such a way that the moving element 342 and the hooking element 35 return to original position due to a restoring force of the spring.

On the other hand, when the hooking element 35 moves to the one side, coupling between the hooked element 321 of the door 32 and the hooking element 35 of the door opening/closing unit 33 is released in such a way that the door 32 is opened while pivoting around the hinge due to the spring provided on the hinge axis.

Then, the administrator takes medicines out of the cell 31, whose door 32 is opened, and closes the door 22.

In this case, the hooked element 321 of the door 32 is coupled with the hooking element 35 returning to the original position and maintains a closed state.

As described above, while taking medicines, the lamp 38 is turned on according to a control signal of the control unit 19 to guide the administrator an opened state of the door 32 and is turned off when the door 32 of the corresponding cell 31 is closed.

Also, the fixing unit 22 fixes the drawer 20 to the withdrawal position not to slide backwards till the doors 32 of the entire cells 31 are closed.

When it is recognized that the doors 32 of the entire cells 31 are closed, the control unit 19 controls the fixing unit 22 to unfix.

When the administrator allows the drawer 20 to slide to the maximum insertion position inside the mounting space 21 of the drawer mounting unit 40, the locking element 42 locks the drawer 20 and finishes discharging medicines.

On the other hand, when all medicines stored in the medicine storage case 30 are discharged and it is necessary to refill, after an access right of the administrator is authenticated, the control unit 19 controls the locking element 42 maintaining the drawer 20 containing a corresponding medicine storage case 30 necessary to be refilled with medicines to unlock.

When the drawer 20 slides to a withdrawal position and a detection signal is transmitted from the withdrawal position detection unit 21, the case locking unit 204 is controlled to unlock in order to separate the medicine storage case 30 from the corresponding drawer 20.

According thereto, the administrator separates the medicine storage case 30 from the drawer 20, mounts the same on the medicine refilling apparatus, and then refills one of the cells 31, necessary to be refilled, with medicines when the door 32 of the corresponding cell 31 is opened.

Through a process as described above, it is possible to store a medicine storage case storing medical supplies having various shapes and sizes such as drugs including tablets, powders, parenteral injections and medical instruments including syringes in a drawer and to discharge the same to an administrator whose access right is authenticated.

### Embodiment 2

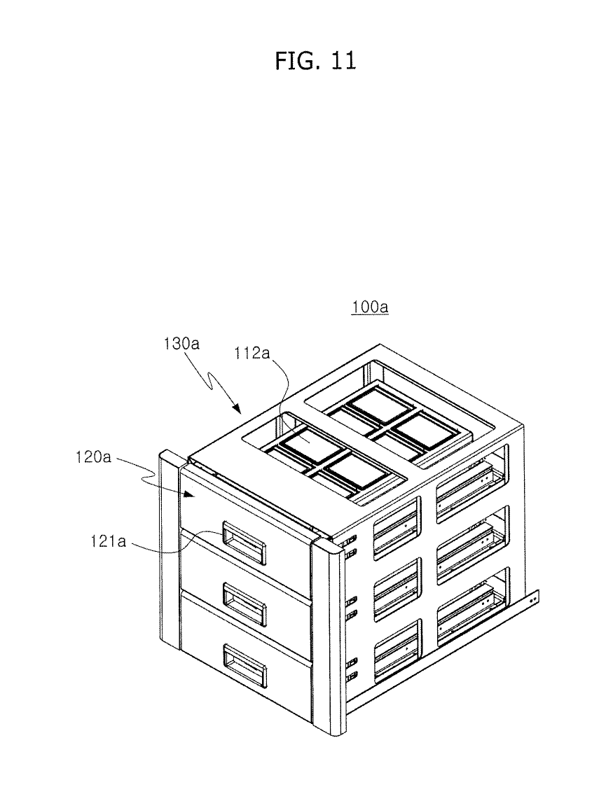

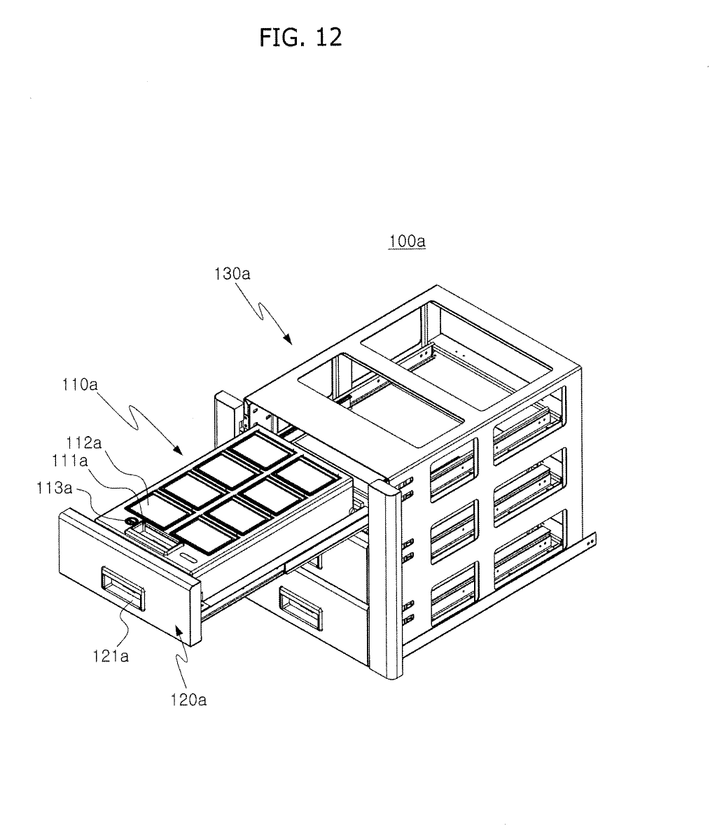

FIG. 11 is a schematic perspective view illustrating a medicine storage apparatus 100a according to another embodiment of the present invention, and FIG. 12 is a schematic perspective view illustrating a drawer 120a of the medicine storage apparatus 100a, which slides forward.

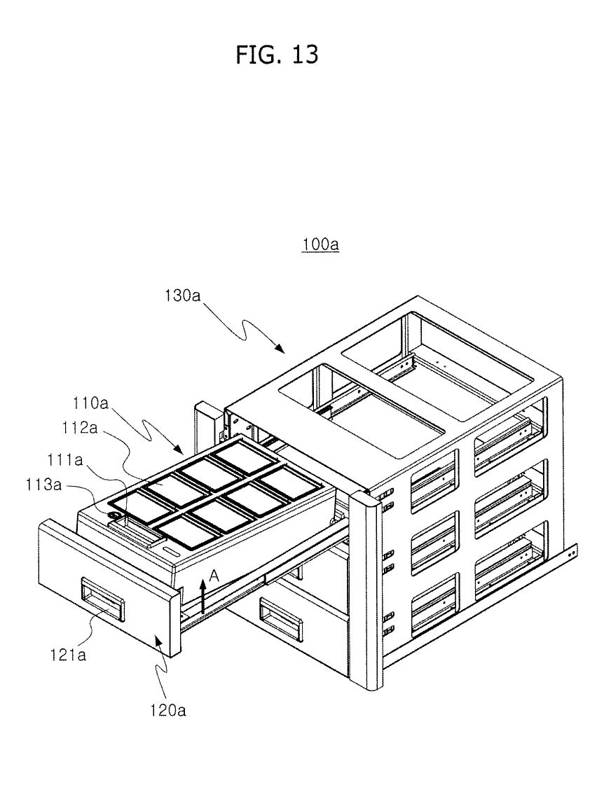

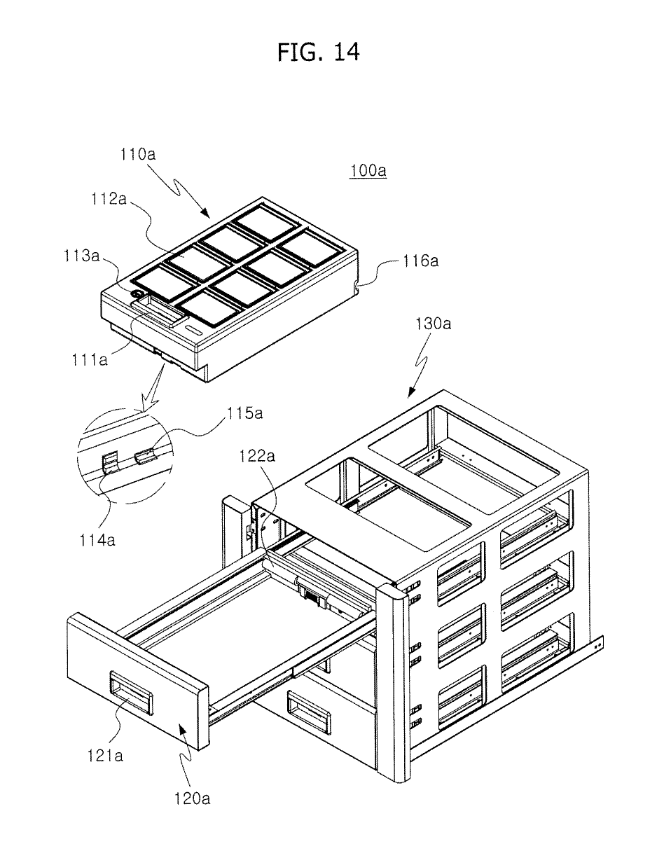

Also, FIG. 13 is a schematic perspective view illustrating a medicine storage case 110a included in the medicine storage apparatus 100a, which pivots upwards from the drawer 120a, and FIG. 14 is a schematic exploded perspective view illustrating the medicine storage apparatus 100a.

Referring to FIGS. 11 to 14, the medicine storage apparatus 100a may include the medicine storage case 110a storing medicines therein and a medicine storage mounting unit on which the medicine storage case 110a is mounted to be detachable. The medicine storage case mounting unit may include a control unit controlling a door opening/closing unit to open a door provided in a cell 112a.

In this case, since the cell 112a, the door, the door opening/closing unit, and a memory chip have the same configuration and effects as those of the medicine storage case 30 described with reference to FIGS. 1 to 10, a detailed description thereof will be omitted hereinafter.

The medicine storage case mounting unit may include the drawer 120a provided with a space storing the medicine storage case 110a and a drawer mounting unit 130a, on which the drawer 120a is arranged in at least one stage and mounted to slidable forward. A front side of the medicine storage case 110a may pivot upwards (A) with the drawer 120a as a reference and may be separated from the drawer 120a.

In other words, when it is necessary to separate the medicine storage case 110a from the drawer 120a, the drawer 120a slides from the drawer mounting unit 130a by applying an external force to a first handle 121a and a pivoting determination element 113a of the medicine storage case 110a is rotated by using a releasing element such as a key, thereby allowing the front side of the medicine storage case 110a to automatically pivot upwards (A).

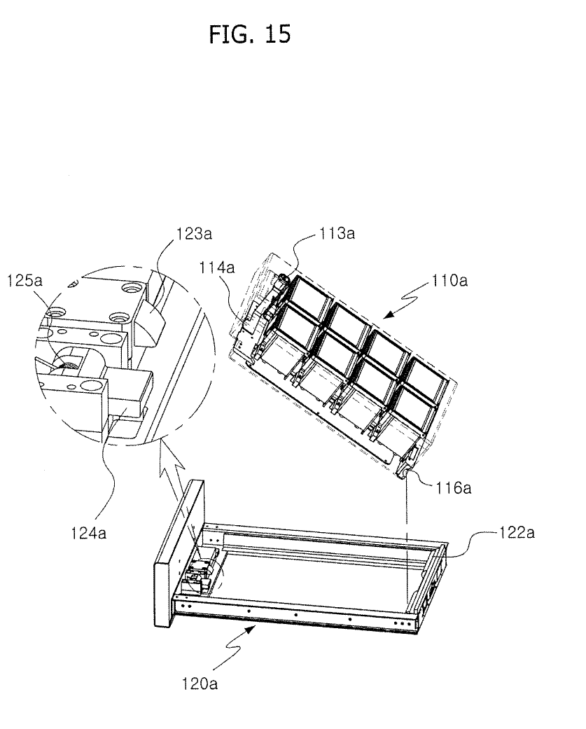

That is, when rotating the pivoting determination element 113a of the medicine storage case 110a by using the releasing element such as the key, a pivoting blocking responding element 114a (refer to FIG. 15) pivoting while being interlocked with the rotation of the pivoting determination element 113a is released from a pivoting blocking element 123a (refer to FIG. 15) included in the drawer 120a in such a way that the front side of the medicine storage case 110a may be in a state of being pivotable upwards (AO and may automatically pivot due to a pivoting force provided by a pivoting force providing element 124a (refer to FIG. 15), the pivoting force being generated by an elastic deformation element 125a (refer to FIG. 15).

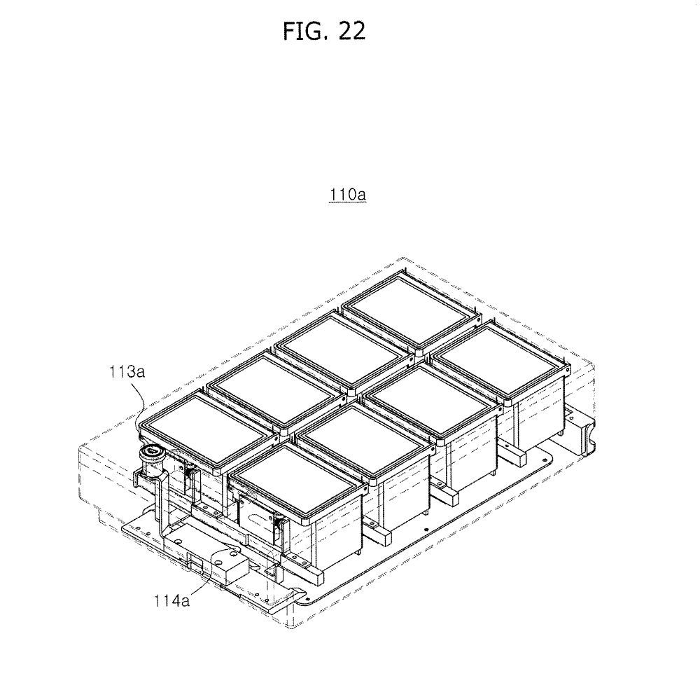

A detailed description thereof will be described with reference to FIGS. 15 and 22.

On the other hand, when the front side of the medicine storage case 110a pivots upwards (A), the administrator may perfectly separate the medicine storage case 110a from the drawer 120a by holding a second handle 111a of the medicine storage case 110a and applying an external force upwards (A) and the separated medicine storage case 110a may be mounted on an additional medicine refilling apparatus and may be refilled with necessary medicines.

FIGS. 15 to 19 are schematic perspective views illustrating a process of mounting the medicine storage case 110a included in the medicine storage apparatus 100a of FIG. 11 on the drawer 120a.

Referring to FIG. 15, when it is necessary to refill the medicine storage case 110a with new medicines, the new medicines may be supplied by using an additional medicine refilling apparatus and then only an administrator having a justifiable right may be allowed to take medicines therefrom.

For this, a rear side of the medicine storage case 110a may include a pivoting-guiding element 116a formed to be depressed and the drawer 120a may include a pivoting guiding responding element 122a formed to be protruded to correspond to the pivoting-guiding element 116a, in response to the rear side.

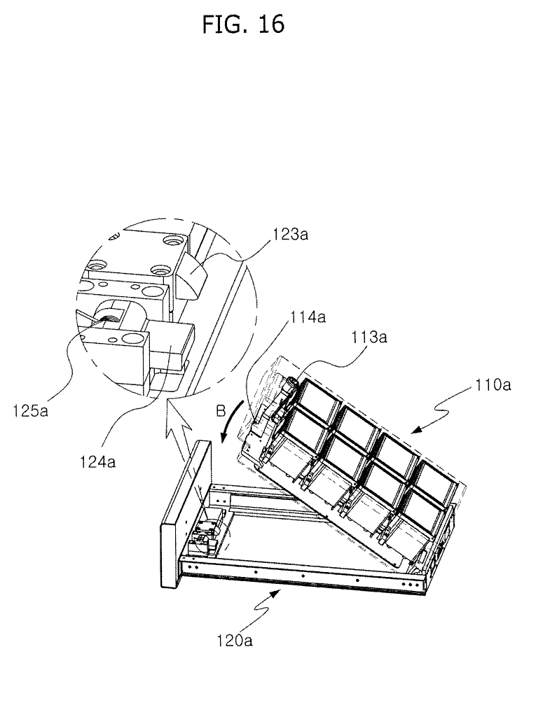

That is, as shown in FIG. 16, the administrator may prepare the medicine storage case 110a to be mounted on the drawer 120a by closely attaching the pivoting-guiding element 116a formed on the rear side of the medicine storage case 110a to the pivoting guiding responding element 122a and applying an external force downwards (B) to the front side of the medicine storage case 110a.

In this case, the pivoting-guiding element 116a and the pivoting guiding responding element 122a are not limited to being formed on the medicine storage case 110a and the drawer 120a but may be formed contrary thereto or may be alternately formed.

On the other hand, it is necessary to allow the pivoting blocking responding element 114a to pivot by rotating the pivoting determination element 113a by using the releasing element such as the key to mount the medicine storage case 110a on the drawer 120a. When the pivoting blocking responding element 114a pivots, the pivoting blocking responding element 114a may pivot downwards (B) without being hooked by the pivoting blocking element 123a included in the drawer 120a.

In detail, the pivoting blocking element 123a may be formed to be protruded from the drawer 120a toward the front side of the medicine storage case 110a. Whether to hook the pivoting blocking responding element 114a on the pivoting blocking element 123a may be determined according to whether the pivoting blocking responding element 114a moves due to the rotation of the pivoting determination element 113a.

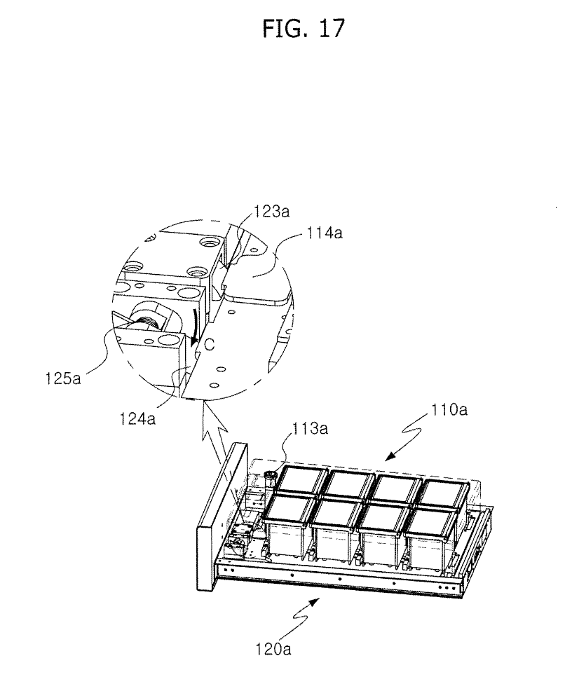

Referring to FIG. 17, when the administrator continuously applies an external force to the front of the medicine storage case 110a downwards (B), the elastic deformation element 125a is elastically deformed in such a way that the pivoting force providing element 124a may pivot (C).

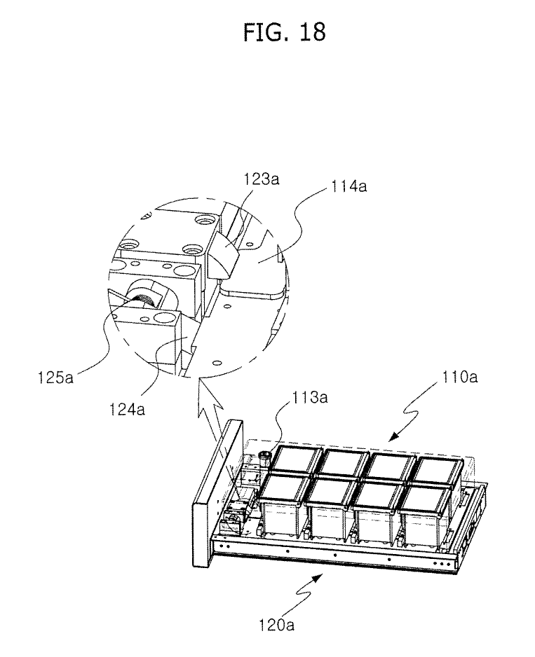

After that, as shown in FIG. 18, the pivoting blocking responding element 114a is allowed to pivot by rotating the pivoting determination element 113a, thereby allowing the pivoting blocking responding element 114a to be hanged on the pivoting blocking element 123a.

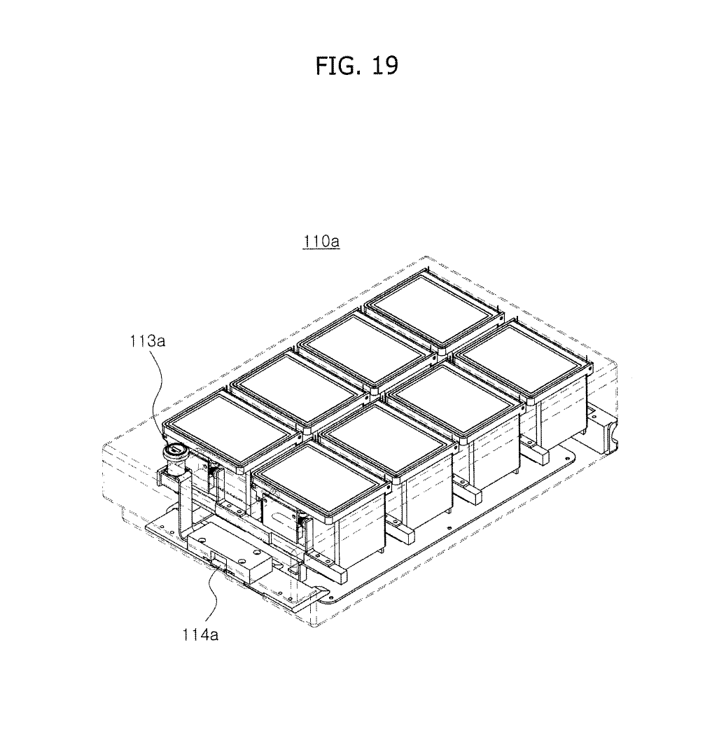

The pivoting blocking responding element 114a in this state is the same as shown in FIG. 19.

Through a process as described above, when the medicine storage case 110a is mounted on the drawer 120a of the medicine storage case mounting unit, the medicine storage case 110a may receive the pivoting force from the pivoting force providing element 124a by a restoring force occurring due to elastic deformation of the elastic deformation element 125a but may keep a stably fixed state due to the pivoting blocking responding element 114a hanged on the pivoting blocking element 123a.

Finally, whether the medicine storage case 110a pivots or not is determined by whether the pivoting blocking responding element 114a is hanged on the pivoting blocking element 123a.

On the other hand, when the pivoting blocking responding element 114a is hanged on the pivoting blocking element 123a, the lower end of the front of the medicine storage case 110a may include a pivoting force providing responding element 115a (refer to FIG. 14) containing the pivoting force providing element 124a, thereby previously preventing a separation phenomenon of the medicine storage 110a from the drawer 120a.

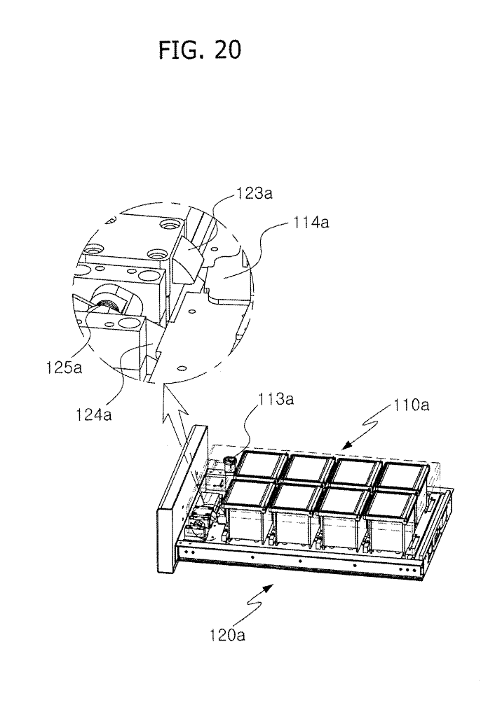

FIGS. 20 to 22 are schematic perspective views illustrating a process of separating the medicine storage case 110a included in the medicine storage apparatus 100a from the drawer 120a.

In advance, the process of separating the medicine storage case 110a included in the medicine storage apparatus 100a from the drawer 120a may be opposite to the process of mounting the medicine storage case 110a included in the medicine storage apparatus 100a onto the drawer 120a, described with reference to FIGS. 15 to 19.

Referring to FIG. 20, the pivoting blocking responding element 114a is allowed to pivot by rotating the pivoting determination element 113a, thereby releasing the pivoting blocking responding element 114a hanged on the pivoting blocking element 123a.

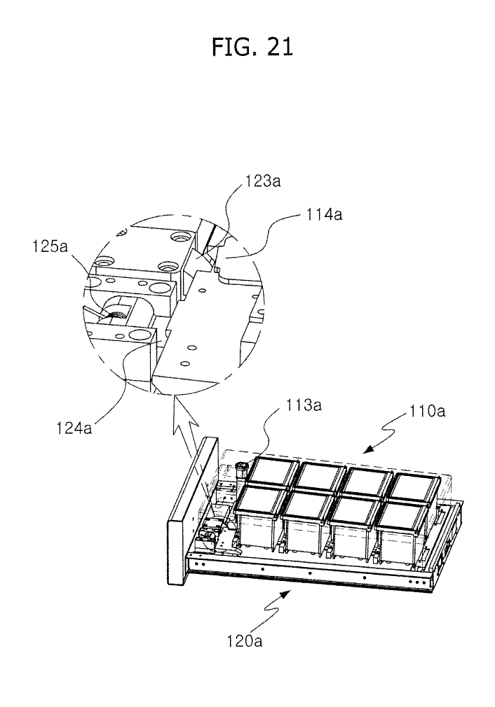

In this case, as shown in FIG. 21, the front of the medicine storage case 110a may be allowed to automatically pivot upwards by the pivoting force of the pivoting force providing element 124a due to the restoring force of the elastic deformation element 125a.

The pivoting blocking responding element 114a in this state is the same as shown in FIG. 22.

When the front of the medicine storage case 110a pivots upwards (A), the administrator holds the second handle 111a of the medicine storage case 110a and applies an external force upwards to perfectly separate the medicine storage case 110a from the drawer 120a.

### Embodiment 3

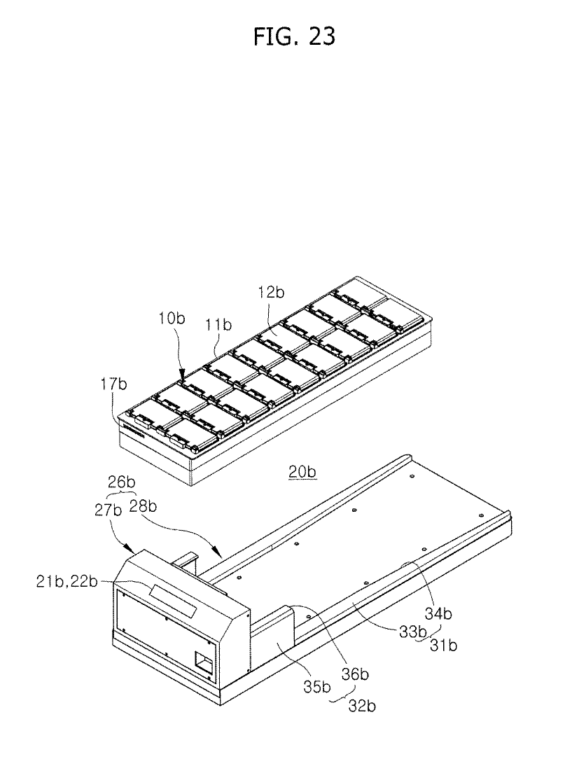

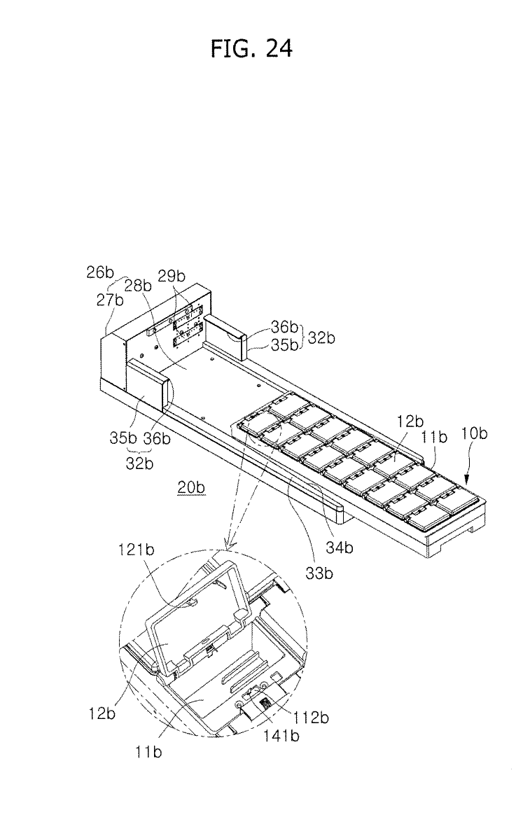

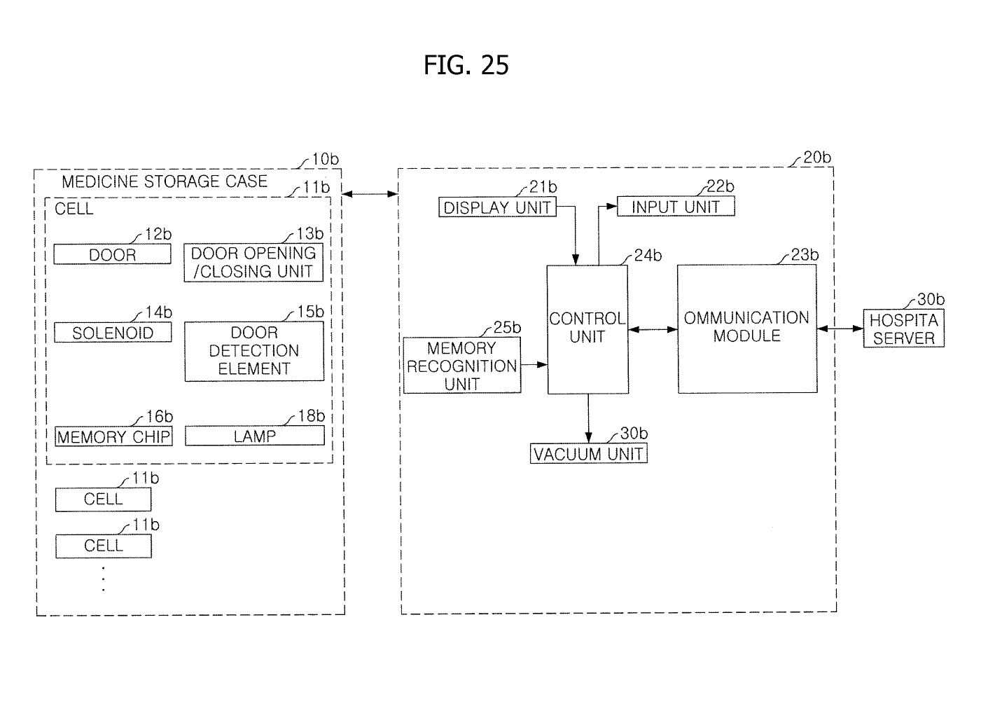

FIG. 23 is a schematic exploded perspective view illustrating a medicine storage apparatus 20b according to a third embodiment, FIG. 24 is a schematic perspective view illustrating the medicine storage apparatus 20b viewed from another angle, and FIG. 25 is a block configuration view illustrating the medicine storage apparatus 20b.

The medicine storage apparatus 20b, as shown in FIGS. 23 to 25, includes a drawer-type medicine storage case mounting unit 26b on which a medicine storage case 10b is mounted, a memory recognition unit 25b electrically connected to a memory chip 16b provided in each of cells 11b of the medicine storage case 10b mounted on the medicine storage case mounting unit 26b and recognizing identification information and medicine information stored in the memory chip 16b, a communication module 23b transmitting information recognized by the memory recognition unit 25b to a hospital server 40b and receiving refilling information of medicines to be inserted or refilling (hereinafter, referred to as refilling) from the hospital server 40b by communicating with the hospital server 40b, and a control unit 24b controlling a door opening/closing unit 13b included in the medicine storage case 10b to open a door 12b provided in each of the cells 11b of the medicine storage case 10b according to the medicine refilling information.

Also, the medicine storage apparatus 20b may further include a display unit 21b installed on a front of the medicine storage case mounting unit 26b and displaying a menu screen for being refilled with medicines and authenticating an access right of an administrator and an input unit 22b receiving a command to execute a desired operation by selecting one of menus displayed on the display unit 21b.

In this case, before describing a detailed configuration of the medicine storage apparatus 20b, a configuration of the medicine storage case 10b will be described in detail with reference to FIGS. 23 to 25.

The medicine storage case 10b is provided with a plurality of the cells 11b to store medical supplies including medicines having various kinds, shapes, and sizes or medical instruments (hereinafter, referred to as medicines).

Each of the cells 11b is formed of a box with an open top, in which a space for storing medicines is formed.

Also, each of the cells 11b includes the door 12b installed on the open top and opening and closing, the door opening/closing unit 13b allowing the door 12b to open and close according to a control signal of the control unit 24b, and the memory chip 16b identification information for each of the cells 11b, given when being initially manufactured and information of medicines stored inside each of the cells 11b.

On a part of a bottom surface of each of the cells 11b, a plurality of guide ribs to easily discharge medicines stored inside the cells 11b may be formed.

On the other hand, a size and a shape of each of the cells 11b may vary with a size and a shape of a contained medicine or a shape and a size of a contained medical instrument.

That is, in the case of the medicine storage case 10b, the cells 11b are formed in various sizes and shapes according to contained medicines and are stored inside a storage space of a drawer (not shown) provided in a medicine supplying apparatus (not shown), to be slidable and detachable.

Also, on a front top surface of each of the cells 11b, a penetration hole 112b is formed to allow a hooked element 121b of the door 12b and a hooking element 141b of the door opening/closing unit 13b, which will be described below, to be coupled thereto.

The door 12b is hinge-coupled with a rear top end of each of the cells 11b and pivots around a hinge axis by a restoring force of a spring installed on the hinge axis.

On a front bottom surface of the door 12b, as shown in FIG. 24, the hooked element 121b engaged with the hooking element 141b of the door opening/closing unit 13b is formed to be protruded.

The door opening/closing unit 13b includes a solenoid 14b operating according to a control signal of the control unit 24b, the hooking element 141b connected to a top end of the solenoid 14b and reciprocating to be coupled with and released from the hooked element 121b of the door 12b, and the door detection element 15b detecting whether the door 12b is opened or closed.

The solenoid 14b, although not shown in the drawings, a coil receiving power and generating a magnetic force, a moving element horizontally moving due to the magnetic force generated by the coil, and the spring installed on one side of the moving element and providing the restoring force to the moving element.

The hooking element 141b is connected to a top of the moving element and engaged with the hooked element 121b. When the solenoid 14b receives power and the coil generates the magnetic force, the moving element moves in one direction and the hooking element 141b horizontally moves along the moving element and is released from the hooked element 121b.

On the contrary, when the power supplied to the solenoid 14b is cut off and the magnetic force is removed, the moving element moves leftwards toward the coil 341 in such a way that the hooking element 141b horizontally moves together with the moving element and then is coupled with the hooked element 121b when the door 12b is closed.

The door opening/closing unit 13b is connected to a PCB 203b included in the drawer mounting unit 40b by using a wire and receives the control signal of the control unit 24b.

The memory chip 16b may include a read-only memory to prevent deleting and amending originally stored information.

On a front surface of the medicine storage case 10b, a first terminal 17b connected to the memory chip 16b of each of the cells 11b by using a wire and coupled with second terminals 29b of the medicine storage apparatus 20b is installed.

Also, a lamp 18b may be installed in each of the cells 11b of the medicine storage case 10b.

The lamp 18b is turned on whether the door 12b is open or not in such a way that the administrator may easily check an open/closed state of the door 12b.

On a top of the medicine storage case 26b, as shown in FIGS. 23 and 24, there are provided a housing 27b, in which the display unit 21b, the input unit 22b, the communication module 23b, the control unit 24b, and the memory recognition unit 25b are installed, and a mounting unit 28b connected to a rear of the housing 27b, on which the medicine storage case 10b is mounted.

On a rear surface of the housing 27b, as shown in FIG. 24, the second terminals 29b are installed in positions corresponding to the first terminal 17b provided on the medicine storage case 10b.

The mounting unit 28b, as shown in FIG. 24, includes a bottom guide unit 31b installed on a top surface of the medicine storage case mounting unit 26b and guiding bottoms of both sides of the medicine storage case 10b and a top guide unit 32b fastening the both sides and a top surface of the medicine storage case 10b, while mounting the medicine storage case 10b.

The bottom guide unit 31b includes a pair of guide blocs 33b installed to be extended long on both sides of a top surface of the medicine storage case mounting unit 26b.

The pair of guide blocks 33b is installed to have an interval corresponding to a width of the medicine storage case 10b, and inclined surfaces 34b are formed to allow the interval of the pair of guide blocks 33b to become wider than the width of the medicine storage case 10b from an intermediate portion to a rear end.

According thereto, since an interval between rear ends of the pair of guide blocks 33b is wider than the width of the medicine storage case 10b, in the present embodiment, the medicine storage case 10b may be moved toward the medicine storage case mounting unit 26b and then may be easily mounted while the medicine storage case 10b is being located between the pair of guide blocks 33b.

The top guide unit 32b includes a pair of guide elements 35b installed on both sides of a top surface of the medicine storage case mounting unit 26b.

The pair of guide elements 35b is installed to have an interval corresponding to a width of the medicine storage case 10b, and bent elements 36b are formed on top ends of the respective guide elements 35b to correspond to a height of the medicine storage case 10b.

Accordingly, the guide elements 35b have an about 7 shape.

As described above, in the present embodiment, both sides and a top surface of a medicine storage case are fastened by installing a pair of guide elements, thereby accurately mounting the medicine storage case to be horizontal and also preventing an arbitrary separation while being mounted.

The memory recognition unit 25b recognizes information stored in the memory chip 16b provided in each of the cells 11b of the medicine storage case 10b, which is transferred via the second terminals 29b, and transfers the recognized information to the control unit 24b.

The control unit 24b transmits administrator information such as an identifier of the administrator and a password inputted via the input unit 22b and the identification information the medicine information transferred from the memory recognition unit 25b to the hospital server 40b by performing communication with the hospital server 40b via the communication module 23b.

Also, the control unit 24b, when authentication for the access right of the administrator is finished by the hospital server 40b, controls the door opening/closing unit 13b provided in one of the entire cells 11b of the medicine storage case 10b, necessary for being refilled with medicines, to open the door 12b of the corresponding one of the cells 11b.

That is, the control unit 24b may control the doors 12b of the entire cells 11b to be opened to refill the entire cells 11b of the medicine storage case 10b with medicines or may control only the door 12b of one of the entire cells 11b to be opened, whose medicines are exhausted and it is necessary to be refilled with medicines.

As described above, in the present embodiment, an access right of an administrator is set for each of cells provided in a medicine storage case and it is allowed to refill only one of the cells, an access right of a corresponding administrator of which is authenticated.

Accordingly, in the present embodiment, it is possible to prevent a loss of medicines and wrong administration thereof by blocking refilling or discharging medicines of an administrator having no justifiable access right and also to prevent medical accidents caused by the misuse of medicines.

On the other hand, the medicine storage apparatus 20b, as shown in FIG. 25, may further include a vacuum unit 30b for removing dusts or foreign materials building up inside each of the cells 11b of the medicine storage case 10b.

The vacuum unit 30b includes an air pump (not shown) provided below the mounting unit 29b, and a cleaning operation is performed by driving of the air pump, in which the air inside each of the cells 11b is discharged via penetration holes formed on a top surface of the medicine storage case mounting unit 26b and formed below each of the cells 11b.

For this, the control unit 24b checks whether the doors 12b of all the cells 11b are closed or not, by using a door detection element 16b of each of the cells 11b and controls the vacuum unit 30b to perform the cleaning operation when the entire doors 12b are closed, to remove dusts or foreign substances inside each of the cells 11b.

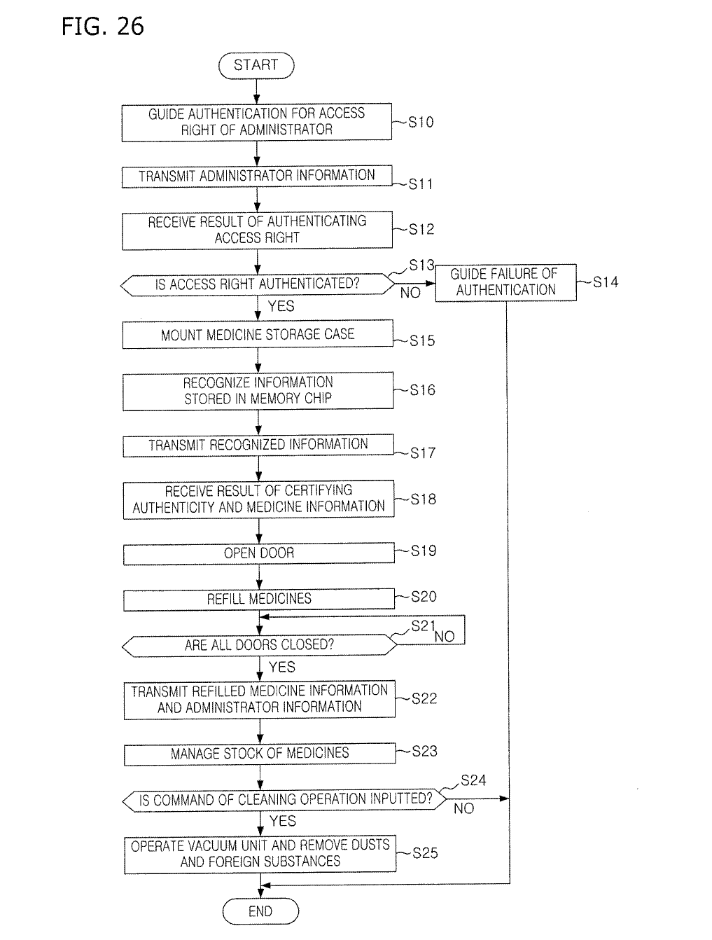

Referring to FIG. 26, a method of controlling the medicine storage apparatus 20b according to still another embodiment of the present invention will be described in detail.

FIG. 26 is a flowchart illustrating the method of controlling the medicine storage apparatus 20b.

The display unit 21b of the medicine storage apparatus 20b displays a screen guiding authentication for an access right of an administrator according to control of the control unit 24b (S10).

When an identifier and a password of the administrator are inputted via the input unit 22b, the communication module 23b transmits the inputted identifier and password to the hospital server 40b (S11) and receives an authentication result from the hospital server 40b (S 12).

Accordingly, the control unit 24b checks whether the access right is authenticated or not, from the authentication result received in the step S12 (S13).

When the administrator is determined not to have justifiable access right, the control unit 24b controls the display unit 21b to guide the administrator that the authentication has failed (S14) and to display a guide screen allowing the administrator to check whether an access right exists.

On the contrary, when the access right of the administrator is authenticated, the control unit 24b controls the display unit 21b to display a guide screen allowing the administrator to mount the medicine storage case 10b storing corresponding medicines.

Then, the medicine storage case 10b is mounted on the mounting unit 28b of the medicine storage apparatus 20b (S15).

In this case, the pair of guide blocks 33b is installed on the bottom guide unit 31b and inclined surfaces 34b are formed on the respective guide blocks 33b to allow an interval therebetween to become wider toward the rear end.

Due thereto, since an interval between rear ends of the pair of guide blocks 33b is wider than the width of the medicine storage case 10b, the administrator may easily mount the medicine storage case 10b while the medicine storage case 10b is being located between the pair of guide blocks 33b.

Together with this, the pair of guide elements 35b installed in front of the mounting unit 28b fixes both side surface and a top surface of the medicine storage case 10b.

According thereto, in the present embodiment, a medicine storage case may be accurately mounted in a mounting unit of a medicine storage apparatus to be horizontal and arbitrary separation thereof may be prevented.

In this case, as the second terminals 29b and the first terminal 17b are coupled with one another and then electrically connected to one another, the memory recognition unit 25b recognizes information stored in the memory chip 16b provided in each of the cells 11b of the medicine storage case 10b (S16).

Then, the control unit 24b controls the communication module 23b to transmit the recognized information to the hospital server 40b (S 17) and to receive a result of certifying authenticity of the corresponding medicine storage case 10b and information of medicines to refill the same from the hospital server 40b (S18).

Sequentially, the control unit 24b transmits a control signal to the door opening/closing unit 13b to open the door 12b of the cell 11b storing the medicines refilled according to the received medicine information

According thereto, the door opening/closing unit 13b of the corresponding cell 11b drives the solenoid 14b according to the control signal of the control unit 24b and opens the door 12b by releasing the hooking element 141b from the hooked element 121b of the door 12b (S19).

As described above, the cell 11b whose door 12b is opened is refilled with medicines (S20).

On the other hand, in the step S21, the control unit 24b checks whether the entire doors 12b are closed after the refilling medicines is finished, by using a detection signal of the door detection element 16b.

As a result of checking, when all the doors 12b are closed, the control unit 24b controls the communication module 23b to transmit information of refilled medicines and information of the administrator to the hospital server 40b (S22).

According thereto, the hospital server 40b manages the stock of medicines in real time by using the received information (S23).

Together with this, the control unit 24b may control the display unit 21b to display a screen for asking whether to clean the inside of each of the cells 11b of the medicine storage case 10b.

When a command for cleaning is inputted via the input unit 22b (S24), the control unit 24b generates a control signal to drive the air pump included in the vacuum unit 30b.

Then, the vacuum unit 30b drives the air pump according to the control signal and removes dusts or foreign substances by discharging the air contained inside each of the cells 11b of the medicine storage case 10b (S25).

Through the process as described above, in the present embodiment, an access right of an administrator may be authenticated by using a medicine storage apparatus manufactured separately from a medicine supplying apparatus and then a door provided in a cell of a medicine storage case, to be refilled with medicines, may be selectively opened and may be refilled with the medicines.

As described above, the exemplary embodiments of the present invention have been described in detail. However, the present invention is not limited to the embodiments and may be variously changed within a range of the scope thereof.

On the other hand, in the present embodiment, the medicine storage apparatus 20b includes the display unit 21b, the input unit 22b, and the control unit 24b but is not limited thereto.

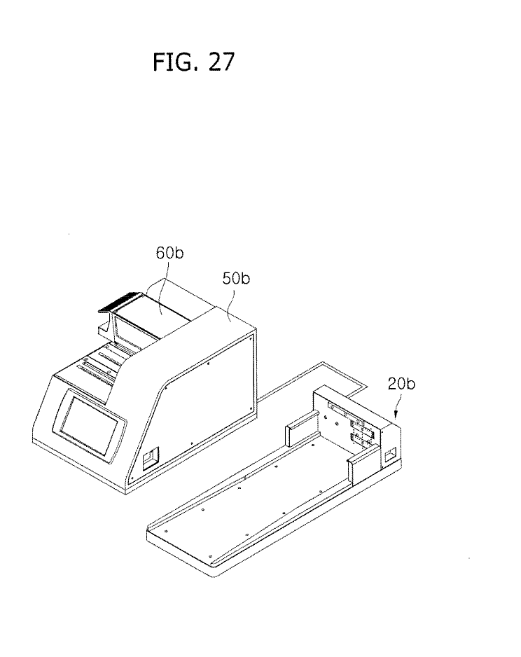

For example, FIG. 27 is a configuration view illustrating another example of the medicine storage apparatus 20b.

In the present embodiment, as shown in FIG. 27, the medicine storage apparatus 20b may be changed into a sub medicine storage apparatus connected to a main medicine storage apparatus 50b manufactured separately to refill a medicine cartridge 60b formed in a box shape with medicines to have communication with the main medicine storage apparatus 50b and refilling medicines by using a display unit, an input unit, a communication unit, and a control unit included in the main medicine storage apparatus 50b.

As described above, in the present embodiment, the main medicine storage apparatus 50b refilling the medicine cartridge 60b with medicines and the medicine storage apparatus 20b refilling the medicine storage case 10b, which have different forms, are connected to each other, thereby refilling the medicine cartridge 60b or the medicine storage case 10b with medicines, which have various forms.

Also, in the present embodiment, a medicine refilling operation is performed by a sub medicine storage apparatus according to a control signal of a control unit included in a main medicine storage apparatus in such a way that the number of elements of the sub medicine storage apparatus may be reduced and manufacturing costs may be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A medicine storage apparatus comprising:
a medicine storage case, which comprises:
a plurality of cells storing medicines therein;
a door installed on a top surface of each of the cells and being opened and closed;
a door opening/closing unit opening and closing the door; and
a memory chip storing identification information for each of the cells while being initially manufactured and information of the medicines stored in each of the cells; and
a medicine storage case mounting unit, on which the medicine storage case is mounted to be detachable, comprising a control unit controlling the door opening/closing unit to open the door provided in each of the cells.

2. The apparatus of claim 1, wherein the door comprises a hooked element protruded from a bottom surface, and
wherein the door opening/closing unit comprises:
a hooking element coupled with and released from the hooked element;
a solenoid receiving power and allowing the hooking element to move in one direction; and
a door detection element detecting whether the door is opened or not.

3. The apparatus of claim 2, wherein the medicine storage case mounting unit comprises:
a drawer in which a space for storing the medicine storage case is provided therein; and
a drawer mounting unit, on which the drawer is mounted to be arranged in at least one stage and to be slidable forward, and
wherein the drawer comprises:
a printed circuit board (PCB) electrically connected to the door detection element and the door opening/closing unit; and
a case locking unit locking or unlocking the medicine storage case.

4. The apparatus of claim 3, wherein the control unit comprises a withdrawal position detection unit detecting a withdrawal state of the drawer and a fixing unit fixing the drawer in a withdrawn state or unfixing the same and is provided in at least one of the drawer and the drawer mounting unit to control the door opening/closing unit and the fixing unit based on detection signals of the door detection element and the withdrawal position detection unit.

5. The apparatus of claim 3, wherein a front plate of the drawer is installed to be hinge-coupled with bottoms of both sides of side plates to mount the medicine storage case therein or to detach the mounted medicine storage case and to be pivotable around the bottoms according to operation of a front opening/closing unit.

6. The apparatus of claim 5, wherein the front opening/closing unit comprises:
brackets installed on both sides of a rear of the front plate and provided with an inclined slot hole, respectively;
a first link element installed on outer surfaces of the side plates, provided with guiding protrusions, inserted into the slot holes of the brackets, installed on a fore-end thereof, and pivoting around a bottom, which is axis-coupled;
a second link element whose fore-end is connected to the first link element and length is controlled by using a plurality of links; and
a fastening module fastening and unfastening a fastening protrusion formed on a rear end of the second link element.

7. The apparatus of claim 6, wherein the fastening module comprises:
a fastening element with a fastening groove, into which the fastening protrusion is inserted; and
a lever element allowing the fastening element to pivot to fasten the fastening protrusion to be inserted into the fastening groove or to release the same.

8. The apparatus of claim 1, wherein the medicine storage case mounting unit comprises:
a drawer in which a space for storing the medicine storage case is provided therein; and
a drawer mounting unit, on which the drawer is mounted to be arranged in at least one stage and to be slidable forward, and
wherein a front side of the medicine storage case pivots upwards with the drawer as a reference and is separated from the drawer.

9. The apparatus of claim 8, wherein, when the front side pivots upwards, to allow the medicine storage case pivots around a rear side thereof, one of the rear side of the medicine storage case and the drawer corresponding to the rear side comprises a pivoting guiding element formed to be depressed and another one thereof comprises a pivoting guiding responding element formed to be protruded to correspond to the pivoting guiding element.

10. The apparatus of claim 8, wherein the drawer comprises a pivoting blocking element protruded toward the front side of the medicine storage case, and
wherein the medicine storage case comprises a pivoting blocking responding element determining whether to pivot from the drawer by determining whether being hooked on the pivoting blocking element depending on whether a position is moved.

11. The apparatus of claim 10, wherein the drawer comprises a pivoting force providing element providing a pivoting force to allow the front side of the medicine storage case to automatically pivot upwards when the pivoting blocking responding element is released from the pivoting blocking element.

12. The apparatus of claim 11, wherein the pivoting force providing element maintains an elastically deformed state when the pivoting blocking responding element is hooked on the pivoting blocking element and provides the pivoting force due to a restoring force for the elastic deformation when the pivoting blocking responding element is released from the pivoting blocking element.

13. The apparatus of claim 11, wherein a bottom end of the front side of the medicine storage case comprises a pivoting force providing responding element containing the pivoting force providing element while the pivoting blocking responding element is hooked on the pivoting blocking element.

14. The apparatus of claim 1, wherein the medicine storage case mounting unit comprises:
a memory recognition unit electrically connected to the memory chip and recognizing identification information and information of the medicines stored in the memory chip; and
a communication module, to perform communication with a hospital server, transmitting the information recognized by the memory recognition unit to the hospital server and receiving refilling information of medicines necessary to be refilled from the hospital server.

15. The apparatus of claim 14, wherein the control unit controls the door opening/closing unit to open only the door of a corresponding one of the cells, to be refilled with medicines, according to the refilling information of medicines.

16. The apparatus of claim 14, wherein the medicine storage case mounting unit comprises:
a display unit installed on a front thereof and displaying a menu screen for medicine-refilling operation and for authentication of an access right of an administrator; and
an input unit for selecting one of menus displayed on the display unit and receiving a command to perform a desired operation.

17. The apparatus of claim 16, wherein the medicine storage case mounting unit comprises:
a bottom guide element guiding bottoms of both sides of the medicine storage case while mounting the medicine storage case; and
a top guide element fastening the both sides and a top surface of the medicine storage case.

18. The apparatus of claim 17, wherein the bottom guide element comprises a pair of guide blocks installed to be extended long on both sides of the top surface of the medicine storage case,
wherein the pair of guide blocks is installed to have an interval therebetween, corresponding to a width of the medicine storage case, and
wherein inclined surfaces are formed on the pair of guide blocks to allow the interval of the pair of guide blocks to become wider than the width of the medicine storage case from an intermediate portion to a rear end.

19. The apparatus of claim 14, wherein second terminals are provided on a rear surface of the medicine storage case mounting unit to be coupled with a terminal connected to the memory chip of the medicine storage case,
wherein the memory recognition unit recognizes information stored in the memory chip via the first terminal and the second terminals, and
wherein the control unit allows the hospital server to certify authenticity of the medicine storage case by using the information recognized by the memory recognition unit.

20. The apparatus of claim 1, further comprising a vacuum unit discharging the air contained each of the cells of the medicine storage case by forming a vacuum to remove dust and foreign substances,
wherein the control unit controls the vacuum unit to operate in a state in which all the doors installed in the respective cells of the medicine storage case are closed.
